(19) United States
(12) Patent Application Publication
(10) Pub. No.: US 2006/0036998 A1
(43) Pub. Date: Feb. 16, 2006

(54) SYSTEM AND METHODS FOR RAPID BUILDOUT OF APPLICATIONS

(75) Inventors: Shawn McKenna, Castle Rock, CO (US); Robert Frisch, Denver, CO (US); Michael Wilson, Highlands Ranck, CO (US); Brian Kohn, Littleton, CO (US)

Correspondence Address: GLENN L. WEBB, P.O BOX 951, CONIFER, CO, 80433, US

(73) Assignee: ANALYTIC SOLUTIONS.COM, INC., Englewood, CO (US)

(21) Appl. No.: 10/710,903

(22) Filed: Aug. 11, 2004

(51) Int. Cl. G06F 9/44

(52) U.S. Cl. 717/120

(57) ABSTRACT

A system that enables the rapid build out of applications that surround a database. The applications are designed to provide centralized management, collaborative workflow and data entry for many different applications and businesses. The applications may be quickly and easily customized to fit the needs of the particular business and industry. The system provides basic components that can be easily customized for a particular application. In this embodiment, the components include a Management component that allows users with access the ability to track the progress of a project; a Workflow component that allows users the ability to collaborate on a project and a Data component that enables data to be entered from disparate sources and forms and transformed into a uniform data format.

### BACKGROUND OF INVENTION

This invention relates to the field of designing applications and particularly to the field of applications built around a database.

Collaborative applications are frequently being utilized to provide workflow management in many different environments. These applications enable multiple users to access a project from remote sites. However, these applications are normally customized to fit a particular industry and even a particular customer. This customization takes considerable time and expense. The design of such a system may take months and involve considerable expense, not only in the design but the implementation of the system. These factors must be considered in the choosing to implement these applications. Additionally, the cost in time and money is even greater when considering the training and implementation of these systems.

For example, a mortgage processing system may allow a mortgage application to be processed at a remote site, then managed through the various stages of approval and processing at a central site. A mortgage originator may receive personal, financial and property information from a borrower. This information is then usually entered into a data entry form by the originator which is then transmitted, often by facsimile, to a mortgage lender. This form is reviewed for completeness and then submitted for underwriting. The progress of the loan is then tracked manually by the originator and the underwriter during the process. Additional information is normally provided as well by appraisers, inspectors, credit reporting agencies and other entities as needed.

Systems that automate much of these tasks have been used, such as disclosed in U.S. Patent Publication 2002/0059137. These systems, as discussed above, are relatively expensive to design and cumbersome to train users. Also, since these systems require the user to learn new proprietary procedures and their application requirements, the compliance and accuracy of use is often minimal.

Another problem with these applications is the amount of time and compliance necessary to ensure that the users are able to implement the system. The users normally have spent considerable time being trained on a legacy system and may have considerable data stored in the format of the legacy system. The expense of converting this data into the format of the new system as well as training the users on data entry and use of the new system can be considerable.

Thus a need exists for a system to enable applications to be rapidly built and that enable users to use their existing data entry forms.

### SUMMARY OF INVENTION

The present invention provides a solution to these and other needs. The present invention enables the rapid build out of applications that surround a database. The applications are designed to provide project management, collaborative workflow and data entry for many different applications and businesses. The applications may be quickly and easily customized to fit the needs of the particular business and industry.

In a preferred embodiment of the present invention, the system provides basic components that can be easily customized for a particular application. In this embodiment, the components include a Management component that allows users with access the ability to track the progress of a project; a Workflow component that allows users the ability to collaborate on a project and a Data component that enables data to be entered from disparate sources and forms and transformed into a uniform data format.

The system of a preferred embodiment provides a Management component that allows access to progress of a project. The progress including location, schedule, time-line and users allocated to the project as well as other management tasks is displayed. The amount of information displayed may be limited by the access level of the user. The application designer or administrator may designate the users that are allowed access as well as the level of access for that user.

The system of a preferred embodiment provides a Workflow component. The Workflow component enables different users to access the data in the database concerning a project. The component may also provide a mechanism to notify users when information concerning the project is needed from the particular user. The level of access may be limited by the designer or administrator.

The Data component of a preferred embodiment of the present invention enables data concerning the project to be entered into the database. The data may come from data entry forms or from existing data sources.

In one preferred embodiment of the present invention, the Data component has the capability of transforming data from disparate existing data forms or sources into a uniform data format. This greatly reduces the training time, mistakes and increases the compliance and accuracy of the data entry process.

A preferred embodiment of the present invention uses data filters to transform data from existing data sources and forms into a uniform data format.

In another preferred embodiment, the Data component analyzes the attributes surrounding a data field to determine the nature of the data in order to transform the existing data field to a uniform data field in the database.

In another preferred embodiment, the Data component uses XML technology to map the existing data fields to the uniform data fields in the database.

These and other features will be evident from the ensuing detailed description of preferred embodiments and from the drawings.

### BRIEF DESCRIPTION OF DRAWINGS

FIG. 1 is a schematic of the typical build out of an application process.

### DETAILED DESCRIPTION

The present invention, in a preferred embodiment, provides methods and systems for creating applications with a rapid build-out technique. A preferred embodiment of the present invention is described below. It is to be expressly understood that this descriptive embodiment is provided for explanatory purposes only, and is not meant to unduly limit the scope of the present invention as set forth in the claims. Other embodiments of the present invention are considered to be within the scope of the claimed inventions, including not only those embodiments that would be within the scope of one skilled in the art, but also as encompassed in technology developed in the future.

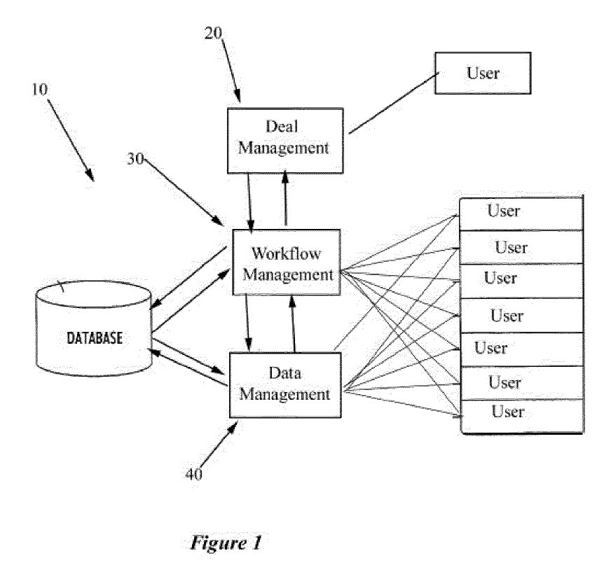

In the preferred embodiment of the present invention, the system 10 includes three components as shown in FIG. 1. These components include a Deal Management component 20, Workflow component 30 and Data component 40. Most collaborative applications will utilize these three components in some form. The Deal Management component enables users to monitor the progress of a deal or work in progress. For example, an originator may initiate deal by inputting data at a remote location. This data may be for the origination of a mortgage, insurance application, government service or any other collaborative application that is being provided with the present method. An administrator may then monitor whether the origination process is completed or still under process. The deal may then be routed to a review process and then to a processing service. The final step may be an approval review. Another example may include the progress of a sales process. The sales process may include the initial contact, the follow-up and the closing of the sales prospect. Then the placement of the sales order, manufacture or picking of the sales items, shipment and payment cycles may also be monitored.

Additional features may also be added during the customization process of the application design. For example, a particular application may also allow the Deal Management component to determine the location of the project, schedule a time line for the project, create notification lists, create a scheduling calendar or any number of features that may be useful in the Deal Management component.

The progress of these may be monitored under the Deal Management component. The level of access to the Deal Management component may be set to allow only access to those involved at a particular step to be enabled with overall access at different levels of management to all steps of the process. This provides instant access to information to those who require such access. This greatly improves the ability to manage the progress of a project.

The second component is the Workflow component 30. The Workflow component allows users to participate in ongoing tasks of the project. For example, a loan originator may enter the data for a mortgage application or an insurance agent enter the data for an insurance application. A reviewer may then review the application to ensure the accuracy of the data that was entered. A processor may then process the application. An appraiser may add an appraisal report. An inspector may add an inspection report. An approver may then decide whether to approve the particular application. The Workflow component 30 allows access to the project for each of the users that require access. It eliminates the need for a paper file to be created and then handled by each of the users. The access may be sequentially or simultaneously depending on the nature of the project. User access levels may be set if desired for each user as well.

This component is accomplished by a client server system that allows users at remote client sites to access a server based application. The Workflow component may reside at the server, and maintain the information at a database located on the server or to which the server controls access. The user may then utilize the application to gain access to the information and the operations needed by that user. Alternatively, the information may be in the form of a document that may be checked in and out as necessary by the users.

The third component of the system of the preferred embodiment of the present invention is the Data component 40. The Data component 40 includes an indexed database. This component provides a unique tool that enables legacy information to be utilized in any application. This enables the system to adapt to the user rather than forcing the user to adapt to the system.

Most existing business have some type of data entry in place. The data may be entered in an existing form with an existing format, such as Excel, Oracle, Word, ASCII, or any number of format types. Further, different departments or locations may have different data entry forms and data formats that are intended to be used in the same application. The preferred embodiment of the present invention is able to retrieve this information and convert it into a unified data format.

In one preferred embodiment of the present invention, the Data module is able to determine the nature of the data and the format of the data by examining the attributes surrounding the data. The Data module then transforms the existing data into a new data format that is uniform for the application. Thus, data from disparate existing data sources and from existing data forms may be used uniformly in the application. For example, in the mortgage application example, data found with the attributes of ###-##-#### in the area of the data entry concerning personal information will cause the application to transform the data to the Social Security data file in the database.

In the preferred embodiment, the system uses an eXtended Markup Language “XML” module is used to parse information received in either the data entry or from stored data. Since the data is typically entered in a common form within an industry or business, the XML module is able to recognize the data and the format being used. For example, a mortgage application will include personal and financial information and that information is generally entered in the same sequence regardless of the data format being used. The XML module can parse this information and then use a Document Type Definition to provide the information in a uniform format. The data is then indexed into the database for quick access. Relevant portions of the information can then be processed by users as needed.

The use of the Data module eliminates the need to create custom data entry fields. This ensures that users will comply with the data entry and reduce the mistakes of data entry as well as minimize training time and expense. The data entry personnel can continue to use their existing forms to enter the data. This is particularly useful in industries and business that utilize different data entry forms and models. For example, a typical mortgage application will require information from an originator, financial institutions, appraisers, inspectors and other sources. Each of these users typically have their own unique form for entering data. The present invention enables each user to continue to utilize their existing data entry form while providing the data in a uniform format.

The use of these three basic components enable a rapid build out for the application. Each component may be uniquely customized as necessary, but the basic building block is already in existence. The application designer does not have to start the application from scratch. The components are essentially a template that is implemented for each new application.

The designer is able to designate for purposes of the Deal Manger component the users that have access to the application and the level of access that each user is provided. An interface can be provided for each user that allows the user to input their identification and password.

The interface then displays for that user all projects that involve that user or that user is monitoring. Different levels of users may have different access privileges to update or display the projects. The designer or administrator can also include features such as location monitoring, scheduling, calendaring, notification and other useful features as desired.

The application designer is able to customize the basic Workflow process for the application as well. The common elements of the Workflow process is the ability to collaboratively enter, retrieve and process data from the indexed database. The Workflow component interacts with the Deal Manager and the Data components to allow different users to access the database and process the data as needed. For example, in the mortgage application example, the originator enters data regarding the applicant, the property in question, and financial information. The appraiser may access information regarding the property and enter additional information. The relevant financial institutions may retrieve credit information and enter additional financial information. The credit scoring agencies may retrieve and add credit information. Other users may process additional information. The Workflow component enables the disparate users to collaboratively access and add information at different access levels. Thus, the designer is able to designate the users that have access to the database, provide notification to the users when their access is needed, and provide the level of access for each user.

The application designer may also customize the Data component as well. The Data component is able to utilize existing data entry forms and data formats. The designer also has the ability to create custom filters for unique data formats and data forms. For example, the designer may be designing an application for a business that has unique and proprietary data entry forms. The designer can quickly create a filter that converts these data fields to a form that the XML module can apply into a uniform table. Also, the designer can create custom tables and reports if desired for that application. The designer may also create filters that transform known data types as well.

The present invention enables a rapid build out of a collaborative workflow application regardless of the type of business or industry. It also enables the application to utilize existing data entry forms even if such data entry forms are widely disparate. The system of a preferred embodiment of the present invention uses three basic components built around an indexed database. Each component provides a basic building block or template that can be quickly customized for the individual application. This reduces the design of application from months to days. This system can be utilized for the design of most applications that require the use of a central database.

It is to be expressly understood that the above described embodiments are provided for explanatory purposes and are not meant to limit the scope of the present invention.

1. A method for building applications, the method comprising the steps of:
providing a database;
providing a management component for monitoring the process of a project;
providing a workflow component for providing collaborative access to the project; and
providing a data entry component that converts data from disparate data entry sources to a uniform data format for storage in said database.

2. The method of claim 1 wherein said step of providing a management component includes the steps of:
providing users that have access to one or more of the group of: location of the project; timeline of progress of the project; schedule of the project.

3. The method of claim 1 wherein said step of providing a management component includes the steps of:
providing users that have access to a project; and
providing different levels of access to different users.

4. The method of claim 1 wherein said step of providing a workflow component includes the steps of:
providing users that have access to the data in said database concerning a project; and
providing different levels of access to different users.

5. The method of claim 1 wherein said step of providing a workflow component includes the steps of:
providing users that have access to the data in said database concerning a project; and
providing notification to users as their access to the data is needed.

6. The method of claim 1 wherein said step of providing a data entry component that converts data from disparate data entry sources to a uniform data format for storage in said database further includes the steps of:
utilizing XML to transform data from existing data fields to a uniform data entry in said database.

7. The method of claim 1 wherein said step of providing a data entry component that converts data from disparate data entry sources to a uniform data format for storage in said database further includes the steps of:
analyzing the attributes surround a data field to transform data from existing data fields to a uniform data entry in said database.

8. The method of claim 1 wherein said step of providing a data entry component that converts data from disparate data entry sources to a uniform data format for storage in said database further includes the steps of:
applying a data filter to transform data from existing data fields to a uniform data entry in said database.

9. The method of claim 1 wherein said method further includes:
customizing each of said management components, workflow components and data components to fit the needs of the particular operation.

10. A system for building applications, wherein the system comprises:
a database;
a management component for monitoring the process of a project;
workflow component for providing collaborative access to the project; and
a data entry component for converting data from disparate data entry sources to a uniform data format for storage in said database.

11. The system of claim 10 wherein said management component includes:
an interface for displaying to designated users one or more of the group of: location of the project; timeline of progress of the project; schedule of the project.

12. The system of claim 10 wherein said management component includes:
an interface for displaying the progress of a project to users that have access to a project; and
different levels of access to different users.

13. The system of claim 10 wherein said workflow component includes:
an interface for allowing access to the data in said database concerning a project; and
different levels of access to different users.

14. The system of claim 10 wherein said workflow component includes:
an interface for allowing access to the data in said database concerning a project; and
a notification mechanism to users as their access to the data is needed.

15. The system of claim 10 wherein said data entry component includes:
an XML component to transform data from existing data fields to a uniform data entry in said database.

16. The system of claim 10 wherein said data entry component includes:
an analysis component for analyzing the attributes surround a data field to transform data from existing data fields to a uniform data entry in said database.

17. The system of claim 10 wherein said data entry component includes a data filter to transform data from existing data fields to a uniform data entry in said database.

18. The system of claim 10 wherein said system further includes:
customizing each of said management components,
workflow components and data components to fit the needs of the particular operation.
